(19) United States
(12) Patent Application Publication
(10) Pub. No.: US 2006/0168621 A1
(43) Pub. Date: Jul. 27, 2006

(54) Methods and apparatus for rendering information on a device

(76) Inventors: Ravinder Chandhok, Poway, CA (US); Kyle J. McKay, San Francisco, CA (US); Suguru Ishizaki, Pittsburgh, PA (US)

Correspondence Address: QUALCOMM, INC, 5775 MOREHOUSE DR., SAN DIEGO, CA, 92121, US

(21) Appl. No.: 11/243,749

(22) Filed: Oct. 4, 2005

Related U.S. Application Data
(60) Provisional application No. 60/616,323, filed on Oct. 5, 2004.

(51) Int. Cl. H04N 5/445; G06F 3/00; G06F 13/00

(52) U.S. Cl. 725/44; 725/39

(57) ABSTRACT

Methods and apparatus for rendering information on a device. A method is provided for rendering programming information on a device. The method includes obtaining the programming information, and applying one or more rendering techniques to the programming information to produce a program guide, wherein the amount of programming information included in the program guide is optimized. The method also includes rendering the program guide on the device.

### CLAIM OF PRIORITY UNDER 35 U.S.C. §119

The present Application for Patent claims priority to Provisional Application No. 60/616,323 entitled “A METHOD AND APPARATUS FOR DISPLAYING A SCHEDULE OF MEDIA CONTENT” filed Oct. 5, 2004, and assigned to the assignee hereof and hereby expressly incorporated by reference herein.

### BACKGROUND

1. Field

The present Application for Patent relates generally to user interface systems, and more particularly, to methods and apparatus for rendering information on a device.

2. Background

In current content delivery/media distribution systems, programming information that describes a delivery schedule of available content and/or services may be provided to devices in a distribution network. For example, a content distribution server that operates on the distribution network may provide the programming information to devices in communication with the network. Devices receiving the programming information operate to display the information in a two-dimensional program guide (PG) to device users who may then select content or services to be received. For example, a device user views the PG and may then select and subscribe to receive content or services that include multimedia content, clips, programs, scripts, data, customer services, or any other type of content or service.

While the two-dimensional program guide allows devices to display the available content or services in a format familiar to users, the limitations of the rendering resources of the devices may make it difficult for users to navigate the program guide or determine desired selections. For example, a typical portable device incorporates a small display that is generally vertically oriented. As a result, the horizontal space available for the two-dimensional program guide is limited. This limitation makes it difficult to provide users with a sense of the overall content that is scheduled over time. For example, the small display may be able to show what content is currently available, but not content that is available at some time in the future. Thus, device users may have to perform a number of actions to navigate the PG to determine future programming.

Additionally, portable devices may not be capable of receiving frequent updates partially due to the network capacity as well as the devices' storage space. This constraint may result in a two-dimensional program guide with sparse program entries over time. Hence, the two-dimensional program guide results in wasting the limited display space of the device to display time slots with no available programming. Not only does this waste the screen space, but the empty time slots may confuse device users and require additional actions by device users to navigate past empty time slots with no available programming.

Therefore, what is needed is a system that operates to efficiently render a program guide on a device. The system should operate to overcome the problems of conventional systems that are associated with limited display space and sparse programming, so that the amount of programming information that is rendered on the available display can be optimized, and the amount of actions required by users to navigate the program guide can be minimized.

### SUMMARY

In one or more embodiments, a rendering system, comprising methods and apparatus, is provided that operates to render programming information on a device. For example, the system is especially well suited for rendering a two-dimensional program guide on resource-limited portable devices. In one embodiment, the system operates to apply one or more rendering techniques to programming information to produce a program guide that optimizes the amount of programming information that is displayed, and minimizes the amount of actions required by users to navigate the program guide.

In one embodiment, a method is provided for rendering programming information on a device. The method comprises obtaining the programming information, and applying one or more rendering techniques to the programming information to produce a program guide, wherein the amount of programming information included in the program guide is optimized. The method also comprises rendering the program guide on the device.

In one embodiment, apparatus is provided to render programming information on a device. The apparatus comprises processing logic configured to obtain the programming information. The apparatus also comprises rendering logic configured to apply one or more rendering techniques to the programming information to produce a program guide, wherein the amount of programming information included in the program guide is optimized. The apparatus also comprises interface logic configured to render the program guide on the device.

In one embodiment, apparatus is provided for rendering programming information on a device. The apparatus comprises means for obtaining the programming information. The apparatus also comprises means for applying one or more rendering techniques to the programming information to produce a program guide, wherein the amount of programming information included in the program guide is optimized. The apparatus also comprises means for rendering the program guide on the device.

In one embodiment, a computer-readable medium is provided that comprises instructions, which when executed by at least one processor, operate to render programming information on a device. The computer-readable medium comprises instructions for obtaining the programming information. The computer-readable medium also comprises instructions for applying one or more rendering techniques to the programming information to produce a program guide, wherein the amount of programming information included in the program guide is optimized. The computer-readable medium also comprises instructions for rendering the program guide on the device.

In one embodiment, at least one processor is provided that is configured to perform a method for rendering programming information on a device. The method comprises obtaining the programming information, and applying one or more rendering techniques to the programming information to produce a program guide, wherein the amount of programming information included in the program guide is optimized. The method also comprises rendering the program guide on the device.

Other aspects of the embodiments will become apparent after review of the hereinafter set forth Brief Description of the Drawings, Detailed Description, and the Claims.

### BRIEF DESCRIPTION OF THE DRAWINGS

The foregoing aspects of the embodiments described herein will become more readily apparent by reference to the following detailed description when taken in conjunction with the accompanying drawings wherein:

FIG. 1 shows a network that comprises one embodiment of a rendering system;

FIG. 2 shows one embodiment of a rendering system;

FIG. 3 shows one embodiment of a PG rendered on a device display as provided by one embodiment of a rendering system;

FIG. 4 shows one embodiment of a PG in which a skipping technique has been applied by one embodiment of a rendering system;

FIG. 5 shows one embodiment of a PG that comprises a channel skip over a selected channel having sparse programming;

FIG. 6 shows one embodiment of a PG that illustrates when a selected program became available as provided in one embodiment of a rendering system;

FIG. 7 shows one embodiment of a PG that illustrates age identification information of a selected program as provided in one embodiment of a rendering system;

FIG. 8 shows one embodiment of a PG produced by one embodiment of a visual compression technique as provided in one embodiment of a rendering system;

FIG. 9 shows one embodiment of a PG produced by one embodiment of a visual compression technique as provided in one embodiment of a rendering system;

FIG. 10 shows one embodiment of a PG produced by one embodiment of a visual compression technique combined with a filtering technique as provided by in one embodiment of a rendering system;

FIG. 11 shows one embodiment of a PG resulting from the operation of one embodiment of the hybrid rendering technique as provided by in one embodiment of a rendering system; and

FIG. 12 shows one embodiment of a method for rendering information on a device as provided by one embodiment of a rendering system.

### DETAILED DESCRIPTION

The following detailed description describes one or more embodiments of a rendering system. The system is especially well suited for use on portable devices having limited display resources, but may be used with any type of device. For example, the system may be used with a portable device operating in any type of network environment, including but not limited to, communication networks, public networks, such as the Internet, private networks, such as virtual private networks (VPN), local area networks, wide area networks, long haul networks, or any other type of data or communication network. Furthermore, the system may be utilized to render any type of information on a device and is not limited to rendering only programming information.

In one or more embodiments, the rendering system operates to render a two-dimensional PG on a device having limited display resources. For example, programming information is maintained at a distribution server and comprises a list of scheduled content and/or services that are available for devices to receive. A copy of the programming information is downloaded to authorized devices on a distribution network. The devices are generally portable devices having small display screens. When a device receives the information, embodiments of the rendering system operate to apply one or more rendering techniques to produce a two-dimensional PG that can be rendered on the device. The applied rendering techniques optimize the programming information displayed in the PG, and minimize the number of navigation actions required by device users to navigate the PG. As a result, the rendering system overcomes the problems associated with small display screens and avoids the inefficiencies associated with conventional two-dimensional program guides that may include empty time slots because of sparse programming.

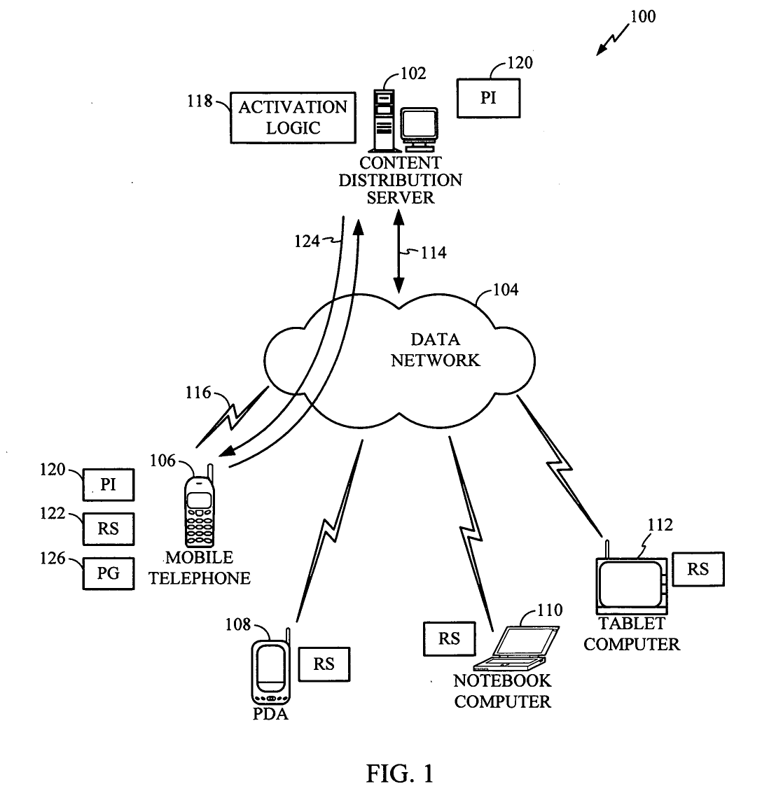

FIG. 1 shows a network 100 that comprises one embodiment of a rendering system. The network 100 comprises a content distribution server 102, a data network 104, and a collection of devices that comprise a mobile telephone 106, a personal digital assistant (PDA) 108, a notebook computer 110 and a tablet computer 112. For the purpose of this description, embodiments of the rendering system are described with reference to the device 106, but the embodiments are equally applicable to the devices 108, 110 and 122 as well. It should also be noted that embodiments of the rendering system are applicable for use with virtually any type or number of devices and are not limited to operate with only the devices 106, 108, 110, and 112 shown in FIG. 1.

The data network 104 may be any type and/or combination of wired and/or wireless networks that allow data, multimedia content, or any other information to be transmitted between the server 102 and the devices. The server 102 communicates with the network 104 via the communication link 114, which may comprise any type of wired or wireless communication channel. The data network 104 provides wireless communication links 116 that allow data to be wirelessly transmitted between the network 104 and the devices 106, 108, 110, and 112. The wireless communication links 116 comprise any type of wireless communication technology.

In one embodiment, the server 102 comprises activation logic 118 and programming information (PI) 120. The activation logic 118 operates to activate a device on the network 104 to allow the device to receive content and/or other available services. For example the activation logic 118 receives identification information from a device and operates to authenticate and/or authorize the device so that the device may request to receive available content and/or services. The Pi 120 comprises a list of content and/or services that are available for authorized devices to subscribe to receive.

As part of the activation process, the server 102 transmits the Pi 120 to the activated device. For example, the PI 120 is transmitted to the device 106 as shown by path 124. The PI 120 is formatted and/or structured in any suitable format. For example, in one embodiment, the PI 120 is organized in sections where each section comprises a section identifier, section descriptor, listing of content and/or services, pricing information, scheduling, ratings, and any other relevant information.

In one embodiment, a rendering system (RS) 122 operates at the device 106 to process the PI 120 to produce an optimized PG 126 comprising the available content and/or services that may be displayed to the device user. The RS 122 may be downloaded to the device from the server 102 during the activation process, provided by a third party or installed on the device during manufacture. The RS 122 operates to apply one or more rendering techniques to the PI 120 to produce the PG 126. A more detailed description of the various rendering techniques applied by the RS 122 is provided in another section of this document.

Once the rendering techniques are applied, the rendered PG 126 presents information from the PI 120 on the limited display resource of the device 106 so that problems associated with horizontal space limitations and/or sparse programming can be overcome. As a result, the rendered PG 126 optimizes the amount of programming information that is displayed, and minimizes the amount of actions required by users to navigate the PG 126. Thus, it is possible for the device user to easily and efficiently navigate the PG to see a variety of programming information on a limited display screen so that content and/or services to be received may be easily selected.

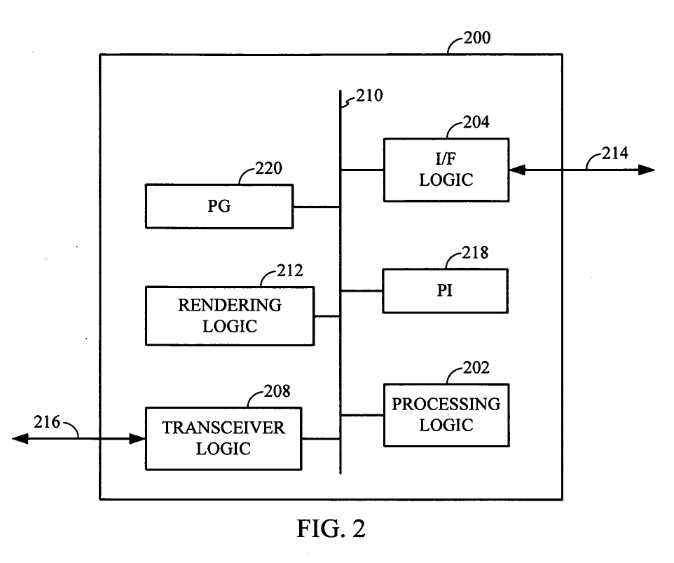

FIG. 2 shows one embodiment of a rendering system 200. For example, the rendering system 200 is suitable for use as the RS 122 shown in FIG. 1. The rendering system 200 comprises processing logic 202, device interface (I/F) logic 204, and transceiver logic 208, all coupled to an internal data bus 210. The rendering system 200 also comprises rendering logic 212, which is also coupled to the data bus 210.

In one or more embodiments, the processing logic 202 comprises a CPU, processor, gate array, hardware logic, memory elements, virtual machine, software, and/or any combination of hardware and software. Thus, the processing logic 202 generally comprises logic to execute machine-readable instructions and to control one or more other functional elements of the rendering system 200 via the internal data bus 210.

The device I/F logic 204 comprise hardware and/or software that allow the rendering system 200 to communicate with internal and external systems. For example, the internal systems may include mass storage systems, memory, display driver, modem, or other internal device resources. The external systems may include user interface devices, displays, printers, disk drives, keyboard, keypad, cursor keys, pointing device, or any other local devices or systems. For example, the device I/F logic 204 operates to receive user inputs from a keypad, and output information to be displayed on a device display through the communication link 214.

In one embodiment, the rendering system is operable for use with a device having limited display resources. For example, the limited display resources may include a small display screen, limited display memory, slow display response, text or graphics limitations or any other type of resource limitation.

The transceiver logic 208 comprises hardware logic and/or software that operate to allow the rendering system 200 to transmit and receive data and/or other information with remote devices or systems using communication channel 216. For example, in one embodiment, the communication channel 216 comprises any suitable type of communication link to allow the rendering system 200 to communicate with a data network. For example, in one embodiment, the transceiver logic 208 operates to receive PI 218 from a remoter server. The rendering system 200 then operates to process the PI 218 to produce a PG 220 that is rendered on a device using the device I/F logic 204.

The PI 218 comprises information in any suitable format that describes content and/or services that are available for devices to receive. For example, the PI 218 may be downloaded from a network server and stored in a local memory of the rendering system 200. The PI 218 comprises information such as content or service identifiers, scheduling information, pricing, and/or any other type of relevant information. In one embodiment, the PI 218 comprises one or more identifiable sections and/or includes information associated with one or more temporal units. For example, the PI 218 describes programming that is associated with one or more content channels for each hour of the day.

The rendering logic 212 comprises a CPU, processor, gate array, hardware logic, memory elements, virtual machine, software, and/or any combination of hardware and software. The rendering logic 212 operates to process the PI 218 to produce a displayable PG 220. For example, the PG 220 is a displayable object that can be rendered by the display resources of a device. In one embodiment, the rendering logic 212 operates to perform or apply one or more rendering techniques to the PI 218 to produce the displayable PG 220. The rendering techniques operate to overcome various limitations associated with displaying programming information on a portable device. For example, the rendering techniques overcome the limitations of a small display screen and/or the sparseness of the programming information to produce an optimized PG 220 for display to the device user. A more detailed description of the rendering techniques is described in another section of this document.

In one or more embodiments, the rendering logic 212 comprises logic to process information in the PI 218 to perform one or more of the following functions to generate an optimized PG 220.

Resolution Control

In one embodiment, the rendering logic 212 operates to control the resolution of the PG 220 that is used to display information from the PI 218. For example, in one embodiment, each temporal unit of the PI 218 is associated with a selected display resolution (i.e., pixels per inch) of the PG 220. In this embodiment, the system operates to control the number of display pixels allocated to each temporal unit. In another embodiment, the system controls the resolution or size of the temporal unit in terms of time (i.e., minutes, hours, days, etc). In one embodiment, the rendering logic 212 controls the various types of resolution adjustments displayed in the PG 220 based on user inputs. Thus, the amount of display space utilized for each temporal unit can be controlled and/or the amount of time represented by a selected temporal unit can also be controlled.

Filtering

In one embodiment, the rendering logic 212 operates to filter information in the PI 218 to produce the PG 220. For example, in one embodiment, the rendering logic 212 filters the PI 218 based on filter parameters provided by user inputs. The filter parameters may be associated with any content characteristic, such as genre, rating, time duration, or any other characteristic. The rendering logic 212 uses the filter parameters to search the PI 218 to find content that matches or meets the requirements of the filter parameters. This content is then used to generate the PG 220. Thus, the user may enter filter parameters to filter selected content from the PI 218 for rendering in the PG 220.

Sparseness Detection

In one embodiment, the rendering logic 212 operates to detect the sparseness of content in the PI 218. For example, the PI 218 is searched to detect temporal units with no associated content. The rendering logic 212 operates to track the sparseness of the PI 218 so that one or more rendering techniques may be used to provide an optimized PG 220 that overcomes the disadvantages of displaying empty temporal units.

Age Detection

In one embodiment, the rendering logic 212 operates to detect when content becomes available and/or the age of selected content in the PI 218. For example, the rendering logic 212 searches the PI 218 to detect age/availability of selected content. The rendering logic 212 operates to provide this information as needed to optimize the information in the PG 220.

In one embodiment, the rendering system 200 comprises program instructions stored on a computer-readable medium, which when executed by at least one processor, for instance, the processing logic 202, provides the functions described herein. For example, the program instructions may be loaded into the rendering system 200 from a computer-readable media, such as a floppy disk, CDROM, memory card, FLASH memory device, RAM, ROM, or any other type of memory device or computer-readable medium that interfaces to the rendering system 200 through the device I/F logic 204. In another embodiment, the instructions may be downloaded into the rendering system 200 from an external device or network resource that interfaces to the rendering system 200 through the transceiver logic 208. The program instructions, when executed by the processing logic 202, provide one or more embodiments of a rendering system as described herein.

During operation of one or more embodiments of the rendering system, one or more of the following functions are performed.
1. Programming information is received that describes content and/or services available to a device. In one embodiment, the programming information comprises one or more identifiable sections (i.e., service levels, blocks, time intervals, genre, ratings, etc.) that describe the available content and services.
2. A determination is made to determine whether one or more rendering techniques are to be applied to the programming information to produce a displayable PG.
3. If one or more rendering techniques are to be applied to the program information, a determination is made as to which rendering techniques to apply.
4. The selected rendering techniques are applied to the program information to produce a program guide that optimizes the amount of programming information that is displayed, and minimizes the amount of actions required by users to navigate the program guide.
5. The displayable PG is then rendered on the display resources of a device.
6. User inputs may be received to adjust or change the applied rendering techniques.

As a result, one or more embodiments of the rendering system 200 operate to process programming information to produce a displayable object, such as the PG 220, which can be rendered on the available rendering resources of a device. The PG 220 optimizes the programming information that is presented to the user in a way that overcomes the size limitations of the display and/or the sparseness of available programming. Thus, embodiments of the rendering system 200 allow a device user to easily view and efficiently navigate the PG 220 to see available content and/or services.

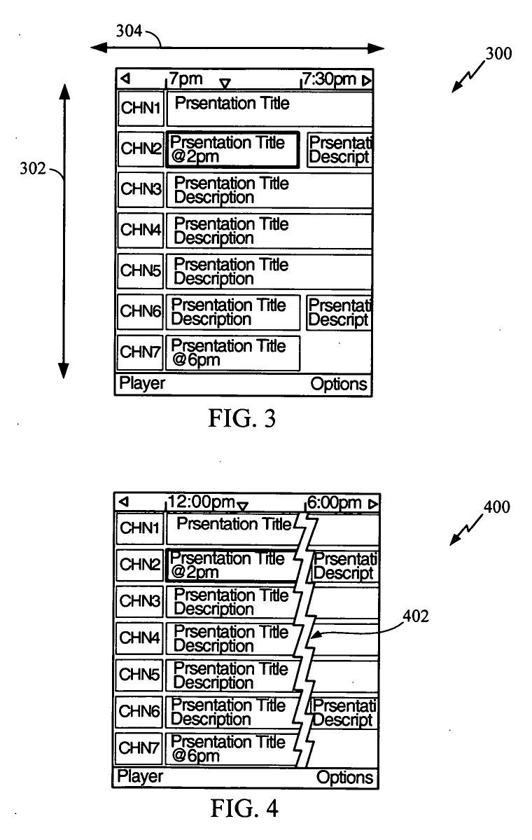

FIG. 3 shows one embodiment of a PG 300 rendered on a device display as provided by one embodiment of a rendering system. For example, the PG 300 comprises information processed from programming information delivered to a portable device. The vertical axis 302 is used to represent available content channels and the horizontal axis 304 is used to illustrate content programs available at selected times. During the presentation of the PG 300, navigation keys available on the device (i.e., left, right, up, and down keys) may be used to browse through the available channels and content. For example, as the user presses the right or left navigation keys, the available content programs scroll horizontally.

The PG 300 presents the available content programs with respect to selected temporal units. For example, in the PG 300, each horizontal increment is based on a temporal unit of thirty (30) minutes. Typically, the temporal unit is equal to the shortest duration of a single program that is available, however, in one or more embodiments, the temporal unit may be set to any selected size or duration.

In one or more embodiments, the rendering system operates to apply one or more selected rendering techniques to the received programming information to produce the PG 300 for rendering on a device. The following is a description of several rendering techniques that may be applied in one or more embodiments of the rendering system. It should be noted that modifications and/or additional render techniques not described below may be applied within the scope of the embodiments.

Technique #1: Re-Configuring Temporal Units

In one embodiment, the rendering system allows a device user to configure the temporal units of the PG. For example, the rendering logic 212 operates to receive user inputs through the device I/F logic 204 and adjust the temporal units of the PG 220 based on the received inputs. For example, the horizontal axis of the PG 220 may be adjusted to display temporal units of hours, days, weeks or of any other desirable unit size. In one embodiment, the rendering logic 212 adjusts the size of the temporal units based on parameters received from the device user. Thus, the rendering system 200 give the device user full control of the size of the temporal units displayed in the PG 220.

Technique #2: Filtering Content

In one embodiment, the rendering system allows a device user to filter the PI 218 to produce the PG 220. The filtering technique allows a device user to filter programs based on user-specified criteria, such as genre (e.g., Sports, News etc.) ratings, or any other criteria. When filtering is used, the resulting PG 220 may be made sparser than without filtering since less content programs are displayed. In one embodiment, the rendering logic 212 operates to filter content from the PI 218 to produce the PG 220. Thus, filtering provides the user with a means to quickly browse through content meeting a specific criteria or genre to find desired programming.

Technique #3: Skipping

Adjusting the temporal units as described in technique #1 is effective if all the content channels are equally and uniformly sparse over time. However, this technique may not be effective when there are some time intervals that are densely populated with programs (e.g., prime time), and other time intervals that are sparsely populated.

In one embodiment, if none of the channels in the programming information has programs scheduled over a selected time interval, the rendering system 200 operates to skip that part of the information when generating the PG 220. As the user scrolls to view the available programs, a skip over the empty time interval occurs. In one embodiment, the rendering logic 212 operates to detect program sparseness and produce the PG 220 with visual skips. Thus, the user doesn't have to scroll through blank temporal units having no programming available to view.

FIG. 4 shows one embodiment of a PG 400 in which the skipping technique has been applied. As shown in the PG 400, no programs are scheduled between the times of 12:30 pm and 6 pm on any of the available channels, so that a skip 402 or “jump” in the PG 400 is shown during this period. This rendering technique allows the device user to jump to the next time slot with programming instead of scrolling through empty time slots where no programs are scheduled.

In one embodiment, the skipping technique includes various indicators (including animation) that may be used to indicate the skip 402 in the PG 400. For example, if sound is available on the device, when the user jumps over the skip 402 in the PG 400, an alert sound may be rendered, which is informative if the user is quickly browsing the PG 400. In one embodiment, the skipping technique is combined with the filtering technique #2 to allow a device user to quickly browse a sparse PG for selected content.

Technique #4: Per-Channel Skipping

The skipping technique #3 described with reference to FIG. 4 may not be useful if the PI 218 includes both dense and sparse content channels so that at least some content is available every temporal unit. In one embodiment, the rendering system addresses this problem by applying a similar skipping technique on a per channel basis. For example, if there are no programs during a selected time interval within a single channel, the rendering system 200 indicates this by providing a channel skip.

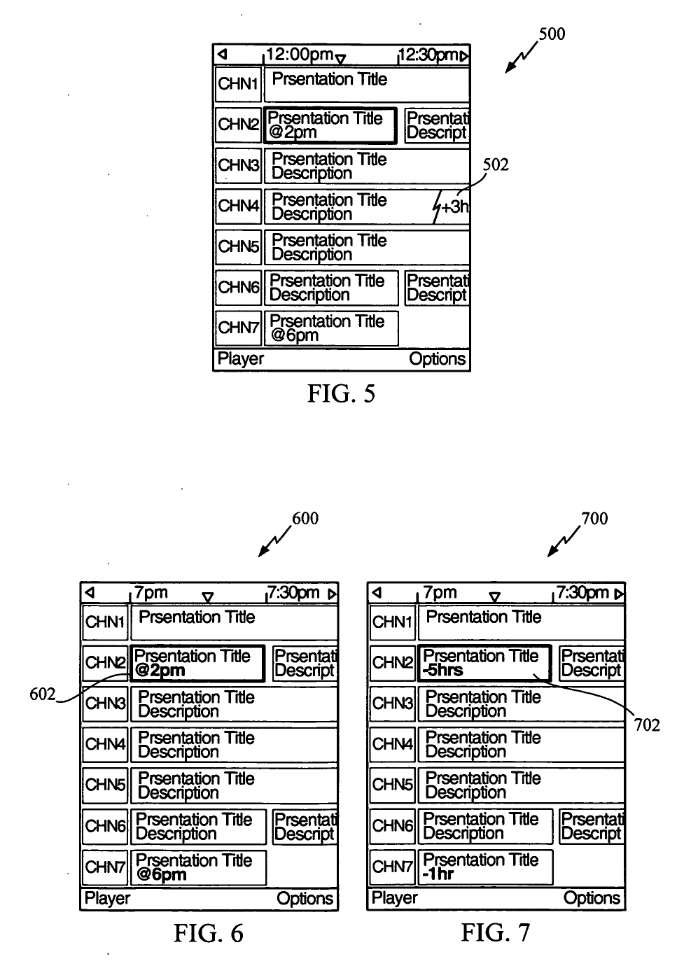

FIG. 5 shows one embodiment of a PG 500 that comprises a channel skip over a selected channel having sparse programming. For example, in the PG 500, channel 4 (CHN4) shows a skip 502 due to lack of programming for this channel at a selected time interval. For example, channel 4 does not have any programs scheduled for three hours after 12:30 pm. The rendering system 200 provides the user with an option to skip over blank programming to the next temporal unit that contains a program on this channel.

In one embodiment, the rendering logic 212 operates to detect programming sparseness on a per-channel basis and incorporate per-channel skipping into the PG 500. In one embodiment, per-channel skipping is activated on a device by using the right navigation key. Alternatively, this can be accomplished by holding the right navigation key for certain duration. If this technique is realized on a device with a pen-based user interface, such as a PDA, per-channel skipping may be performed by tapping a selected region (ump indicator) of the PG. In addition, per-channel skipping may also be combined with the filtering technique #2 as described above.

Technique #5: Availability/Age Identification

In one type of content distribution environment, a program that is available at a particular time may continue to be available for a long duration (i.e., until the next program becomes available). In this case, it is useful for device users to be informed about how old a particular program is. Thus, in one embodiment, the rendering logic 212 operates to provide availability and/or age identification (ID) information related to selected programming.

FIGS. 6-7 show embodiments of PG 600 and PG 700, respectively, where PG 600 shows when a selected program became available and the PG 700 shows age ID information of a selected program. For example, as shown at 602, the program at 7 pm became available at 2 pm, as indicated by the availability information. Furthermore, as shown at 702, the program at 7 pm has an age of 5 hours, as indicated by the age ID information.

Particular implementation of this technique is not limited to the examples shown in FIGS. 6-7. In one or more embodiments, the rendering system operates to show the availability and age of programs in variety of visual or auditory means, including but not limited to, colors, translucency, sounds, and/or icons.

Technique #6: Visual Compression

The visual compression technique operates to provide the user with a sense of program availability and schedule over a long duration. Because of the small display area available on many portable devices, visual compression allows information over an extended time interval to be displayed.

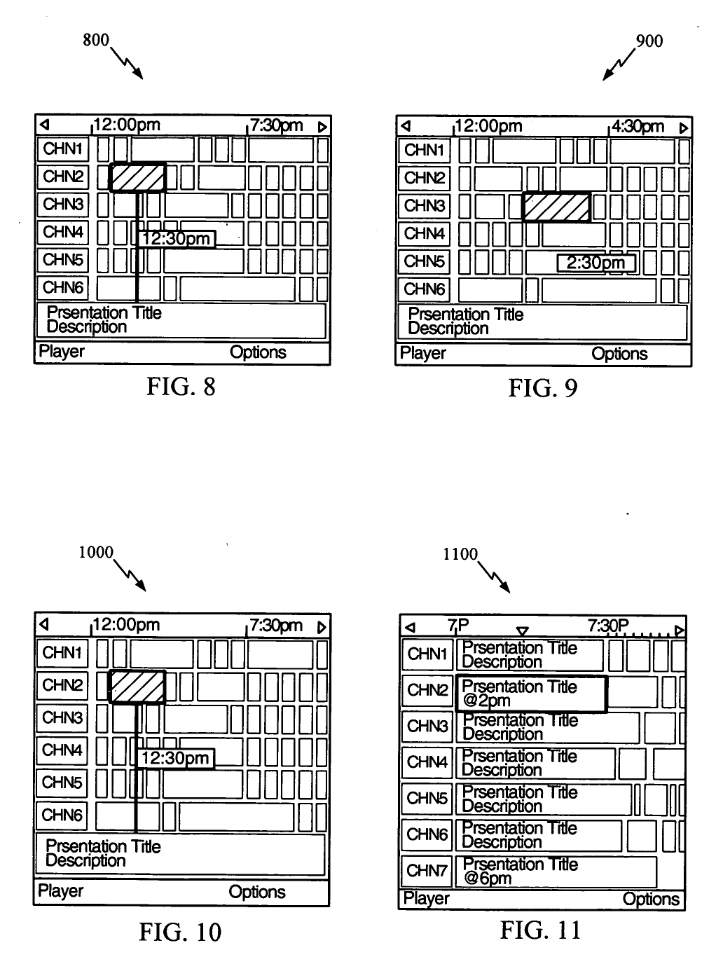

FIGS. 8-9 show embodiments of PG 800 and PG 900, respectively, produced by one or more embodiments of a visual compression technique. As illustrated in PG 800 and 900, a long time interval is compressed into a small display space so that each program is represented by a shaded box without the title and the program description. The title and the description of currently highlighted programs (802, 902) are presented separately at the bottom of each respective PG. In one embodiment, the rendering logic 212 operates to perform the compression technique by adjusting temporal units of selected content in the PG 800 and the PG 900.

FIG. 10 shows the result of one embodiment of a visual compression technique combined with the filtering technique provided by the rendering system 200 to produce PG 1000. In the PG 1000, the shaded boxes indicate a particular type or genre of programs that are specified by the user as described in the filtering technique above. In one embodiment, the rendering logic 212 operates to process the programming information to produce the filtered and compressed PG 1000. Thus, the compressed rendering allows a device user to browse an extended time interval to quickly locate programs of a selected type. The particular visualization method used in FIG. 10 is only one example, and therefore various visual as well as auditory techniques may be used to signify certain groups of programs.

Technique #7: Hybrid Rendering

When using the visual compression technique described above, the user may not be able to read available programs at a glance. In one embodiment, the rendering system addresses this by providing a hybrid rendering technique that combines aspects of the PG shown in FIG. 3 and the visual compression technique described above.

FIG. 11 shows one embodiment of a PG 1100 resulting from the operation of one embodiment of the hybrid rendering technique. In the PG 1100, the very first column (7 pm), uses a wide enough display area so that the title and description of each program can be displayed. However, other columns use smaller display space. For example, in one embodiment, the rendering logic 212 adjusts the temporal units for the programs after the first column to use smaller screen space. Thus, the hybrid rendering technique allows the device user to quickly read an overview of available programs for a particular time, while also allowing the user to look ahead to get a sense of program availability in the next several hours or longer. The above described filtering technique may also be incorporated with the hybrid technique.

Therefore, in one or more embodiments, the rendering system operates to apply one or more rendering techniques to programming information to produce a program guide that optimizes the amount of programming information that is displayed, and minimizes the amount of actions required by users to navigate the program guide. For example, the program guide optimizes the amount of programming information that is displayed in one or more of the following ways.

1. The program guide adjusts the number of temporal units displayed based on user inputs.

2. The program guide is adjusted to skip empty temporal units.

3. The program guide displays information filtered from the programming information to selected only specific programs based on user inputs.

4. The program guide renders a hybrid display so that detailed information can be displayed along with an illustration of content programming over a long time interval.

It should be noted that the previously discussed techniques, such as adjusting temporal units, skipping, per channel skipping, etc. may be used in conjunction or in any combination with the visual compression techniques and the hybrid rendering techniques. Thus, the rendering system is operable to apply any combination of the described techniques to provide a device user with efficient and fast reviewing and search capabilities.

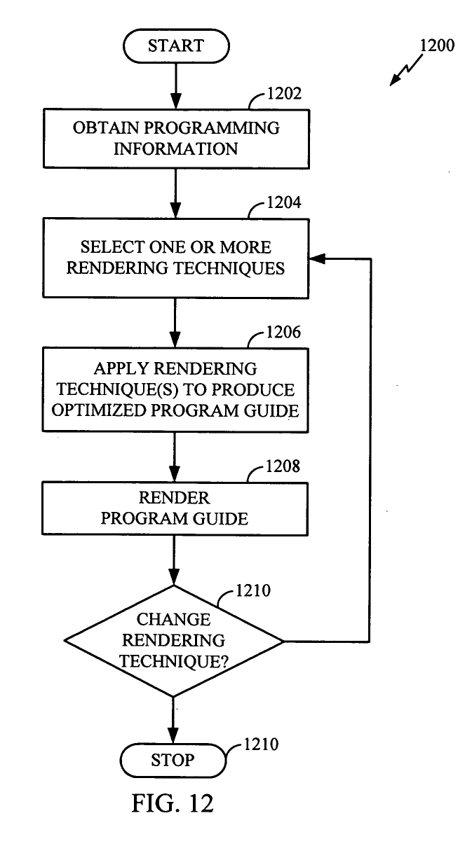

FIG. 12 shows one embodiment of a method 1200 for rendering information on a device. For example, the method 1200 is suitable for use in a resource limited device to render programming information in the form of a displayable PG. For clarity, the method 1200 is described herein with reference to the rendering system 200 in FIG. 2. In one embodiment, at least one processor, such as the processing logic 202, executes program instructions to control the functional elements of the rendering system 200 to perform one or more embodiments of the method 1200 described below.

At block 1202, programming information is obtained. For example, the programming information 218 is received at the rendering system 200. In one embodiment, the programming information 218 is downloaded to the rendering system 200 from a content server through the transceiver logic 208.

At block 1204, one or more rendering techniques are selected. For example, in one embodiment, the rendering logic 212 analyzes the PI 218 to determine which of the available rendering techniques to apply to the PI 218 to produce the PG 220. In another embodiment, the rendering logic 212 receives user inputs through the device I/F logic 204 and processes the user inputs to determine which of the available rendering techniques to apply to the PI 218 to produce the PG 220. For example, the rendering logic 212 receives device navigation key inputs and processes these inputs to determine which if any of the available rendering techniques are to be applied to the PI 218 to produce the PG 220.

At block 1206, one or more of the available rendering techniques are applied to programming information to produce a displayable program guide. For example, the rendering logic 212 processes the PI 218 based on the rendering techniques selected at block 1204 to produce the PG 220. As a result, the PG 220 optimizes the amount of programming information that is displayed, and minimizes the amount of actions required by users to navigate the PG 220.

At block 1208, the displayable program guide is rendered on the device. For example, the processing logic 202 or the rendering logic 212 operate to output the PG 220 to a device display using the device I/F logic 204. As a result, the device user may view the PG 220, which presents information from the PI 218 in a manner that is easy and efficient for a device operator to view and select. For example, the applied rendering techniques maximize the programming information displayed in the PG 220, and minimize the number of navigation actions required by a device user to navigate the PG 220. As a result, the rendering system overcomes the problems associated with small display screens and avoids the inefficiencies associated with conventional two-dimensional program guides that may include empty time slots because of sparse programming.

At block 1210, a test is performed to determine if the rendering techniques used to process the programming information need to be adjusted, or if new rendering techniques need to be used. For example, after viewing the displayed PG 220, the user may input one or more inputs using a keypad, pointing device, cursor keys, or any other type of user input device. In one embodiment, the rendering logic 212 receives the user inputs through the device I/F logic 204 and processes these inputs to determine one or more actions to be taken. For example, the rendering logic 212 determines from the user inputs that a new rendering technique should be used to process the PI 218 to produce adjustments to the PG 220. In another embodiment, the rendering logic 212 determines from the user inputs that an adjustment to a previously used rendering technique should be performed. For example, the user may request an adjustment to the amount of visual compression used in the visual compression rendering technique. Thus, if the rendering techniques need to be changed or adjusted, the method proceeds to block 1204. If the existing rendering of the PG 220 is acceptable, the method ends at block 1210.

Thus, the method 1200 operates to render programming information on a device having limited display resources. One or more rendering techniques are used to allow the rendered information to be easily viewed by a device user. For example, the applied rendering techniques maximize the programming information displayed in a PG, and minimize the number of navigation actions required by a device user to navigate the PG. It should be noted that the method 1200 represents just one implementation and that other implementations are possible within the scope of the embodiments.

Accordingly, while one or more embodiments of a rendering system have been illustrated and described herein, it will be appreciated that various changes can be made to the embodiments without departing from their spirit or essential characteristics. Therefore, the disclosures and descriptions herein are intended to be illustrative, but not limiting, of the scope of the invention, which is set forth in the following claims.

What is claimed is:

1. A method for rendering programming information on a device, the method comprising:
obtaining the programming information;
applying one or more rendering techniques to the programming information to produce a program guide, wherein the amount of programming information included in the program guide is optimized; and
rendering the program guide on the device.

2. The method of claim 1, wherein said applying comprises adjusting a size characteristic of one or more temporal units associated with the programming information to produce the program guide.

3. The method of claim 1, wherein said applying comprises filtering the programming information to produce the program guide.

4. The method of claim 1, wherein said applying comprises skipping one or more portions of the programming information to produce the program guide.

5. The method of claim 4, wherein said skipping comprises skipping one or more portions of the programming information on a per channel basis to produce the program guide.

6. The method of claim 1, wherein said applying comprises compressing one or more portions of the programming information to produce the program guide.

7. The method of claim 6, further comprising filtering the one or more portions of the programming information to produce the program guide.

8. Apparatus configured to render programming information on a device, the apparatus comprising:
processing logic configured to obtain the programming information;
rendering logic configured to apply one or more rendering techniques to the programming information to produce a program guide, wherein the amount of programming information included in the program guide is optimized; and
interface logic configured to render the program guide on the device.

9. The apparatus of claim 8, wherein said rendering logic comprises logic configured to adjust a size characteristic of one or more temporal units associated with the programming information to produce the program guide.

10. The apparatus of claim 8, wherein said rendering logic comprises logic configured to filter the programming information to produce the program guide.

11. The apparatus of claim 8, wherein said rendering logic comprises logic configured to skip one or more portions of the programming information to produce the program guide.

12. The apparatus of claim 11, wherein said logic configured to skip operates to skip one or more portions of the programming information on a per channel basis to produce the program guide.

13. The apparatus of claim 8, wherein said rendering logic comprises logic configured to compress one or more portions of the programming information to produce the program guide.

14. The apparatus of claim 13, further comprising logic configured to filter the one or more portions of the programming information to produce the program guide.

15. Apparatus for rendering programming information on a device, the apparatus comprising:
means for obtaining the programming information;
means for applying one or more rendering techniques to the programming information to produce a program guide, wherein the amount of programming information included in the program guide is optimized; and
means for rendering the program guide on the device.

16. The apparatus of claim 15, wherein said means for applying comprises means for adjusting a size characteristic of one or more temporal units associated with the programming information to produce the program guide.

17. The apparatus of claim 16, wherein said means for applying comprises means for filtering the programming information to produce the program guide.

18. The apparatus of claim 16, wherein said means for applying comprises means for skipping one or more portions of the programming information to produce the program guide.

19. The apparatus of claim 18, wherein said means for skipping comprises means for skipping one or more portions of the programming information on a per channel basis to produce the program guide.

20. The apparatus of claim 16, wherein said means for applying comprises means for compressing one or more portions of the programming information to produce the program guide.

21. The apparatus of claim 20, further comprising means for filtering the one or more portions of the programming information to produce the program guide

22. A computer-readable medium comprising instructions, which when executed by at least one processor, operate to render programming information on a device, the computer-readable medium comprising:
instructions for obtaining the programming information;
instructions for applying one or more rendering techniques to the programming information to produce a program guide, wherein the amount of programming information included in the program guide is optimized; and
instructions for rendering the program guide on the device.

23. The computer-readable medium of claim 22, wherein said instructions for applying comprise instructions for adjusting a size characteristic of one or more temporal units associated with the programming information to produce the program guide.

24. The computer-readable medium of claim 22, wherein said instructions for applying comprise instructions for filtering the programming information to produce the program guide.

25. The computer-readable medium of claim 22, wherein said instructions for applying comprises instructions for skipping one or more portions of the programming information to produce the program guide.

26. The computer-readable medium of claim 25, wherein said instructions for skipping comprises instructions for skipping one or more portions of the programming information on a per channel basis to produce the program guide.

27. The computer-readable medium of claim 22, wherein said instructions for applying comprises instructions for compressing one or more portions of the programming information to produce the program guide.

28. The computer-readable medium of claim 27, further comprising instructions for filtering the one or more portions of the programming information to produce the program guide

29. At least one processor configured to perform a method for rendering programming information on a device, the method comprising:
obtaining the programming information;
applying one or more rendering techniques to the programming information to produce a program guide, wherein the amount of programming information included in the program guide is optimized; and
rendering the program guide on the device.

30. The method of claim 29, wherein said applying comprises adjusting a size characteristic of one or more temporal units associated with the programming information to produce the program guide.

31. The method of claim 29, wherein said applying comprises filtering the programming information to produce the program guide.

32. The method of claim 29, wherein said applying comprises skipping one or more portions of the programming information to produce the program guide.

33. The method of claim 32, wherein said skipping comprises skipping one or more portions of the programming information on a per channel basis to produce the program guide.

34. The method of claim 29, wherein said applying comprises compressing one or more portions of the programming information to produce the program guide.

35. The method of claim 34, further comprising filtering the one or more portions of the programming information to produce the program guide
